(19) United States
(12) Patent Application Publication
(10) Pub. No.: US 2008/0018569 A1
(43) Pub. Date: Jan. 24, 2008

(54) ORGANIC LIGHT EMITTING DIODE DISPLAY DEVICE AND DRIVING METHOD THEREOF

(75) Inventors: Si Duk SUNG, Seoul (KR); Chun Seok Ko, Hwasung-si (KR); Kyeng Eun Roh, Seongnam-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/778,200

(22) Filed: Jul. 16, 2007

(30) Foreign Application Priority Data
Jul. 19, 2006 (KR) 10-2006-0067501

(51) Int. Cl. G09G 3/32

(52) U.S. Cl. 345/82

(57) ABSTRACT

An organic light emitting diode display device includes; a display panel including a pixel connected to a gate line and a data line, gate and data driving circuits which drive the gate and data lines, respectively, at least one temperature sensor disposed on the display panel which senses a temperature of the display panel, a sensor driving unit which converts a temperature signal supplied from the temperature sensor into a digital temperature signal, a timing controller which supplies the gate driving circuit with a control signal, supplies the data driving circuit with a control signal and a data signal, and generates a gamma reference voltage control signal according to the digital temperature signal, and a digital to analog converter which generates a gamma reference voltage which varies according to the gamma reference voltage control signal and supplies it to the data driving circuit.

This application claims priority to Korean Patent Application No. 2006-67501, filed on Jul. 19, 2006, and all the benefits accruing therefrom under 35 U.S.C. § 119, the contents of which in its entirety are herein incorporated by reference.

### BACKGROUND OF THE INVENTION

1. Field of the Invention

The present invention relates to an organic light emitting diode (“OLED”) display device and a driving method thereof. More particularly, the present invention relates to an OLED display device capable of constantly maintaining a temperature of an OLED panel, adjusting gamma voltages in accordance with the temperature of the OLED panel and a driving method of the OLED display device.

2. Description of the Related Art

An organic light emitting diode (“OLED”) display device is a type of flat display device which uses an electroluminescence phenomenon of an organic material. OLED display devices display an image through an OLED which radiates light by applying an electric current to an anode electrode and a cathode electrode with an organic light emitting material injected therebetween. An electron is injected into the organic light emitting material by the cathode and a hole is injected into the organic light emitting material by the anode; when the electron and hole are combined, they form an exciton. The exciton may then emit a photon in the visible spectrum.

An OLED display device does not require an additional light source, such as the backlight used in a liquid crystal display. Use of an OLED in a display device may reduce a volume and a weight of the display device. Further, the OLED display device may have an improved energy efficiency compared to other display types. The OLED achieves the improved energy efficiency by using less power during operation. OLED displays also have the advantages of having a high degree of brightness and a fast response time. Thus the OLED display device is well suited to applications in electronic products, for example, a mobile device or a large-sized television.

However, because the OLED display device is a self-emissive display, it generates heat during operation. The heat generated in the OLED display device proportionally increases as brightness increases, as shown in FIG. 1. The increase in the temperature of the OLED display device will in turn lead to an increase in the brightness of the OLED display device. This sets up a feedback loop where due to a repetitive process, the temperature of the OLED display device gradually increases.

As a result, there has been a problem that uniform color display becomes more difficult as the temperature and brightness of the OLED increases. Further, there has been a problem that the lifespan of the OLED panel is shortened when the temperature of the OLED panel increases beyond a desired temperature range.

### BRIEF SUMMARY OF THE INVENTION

One aspect of the present invention provides an organic light emitting diode display device capable of constantly maintaining the temperature of an organic light emitting diode display panel varying a gamma reference voltage according to the temperature of the organic light emitting diode display panel and a driving method thereof.

In one exemplary embodiment of the present invention, the display device includes a display panel including a pixel connected to a gate line and a data line, a gate driving circuit which drives the gate line, a data driving circuit which drives the data line, at least one temperature sensor disposed on the display panel which senses a temperature of the display panel, a sensor driving unit which converts a temperature signal supplied from the temperature sensor into a digital temperature signal, a timing controller which supplies the gate driving circuit with a control signal, supplies the data driving circuit with a control signal and a data signal, and generates a gamma reference voltage control signal according to the digital temperature signal supplied from a sensor driving unit, and a digital to analog converter which generates a gamma reference voltage which varies according to the gamma reference voltage control signal and supplies the data driving circuit with the gamma reference voltage.

The exemplary embodiment of a display device may further include a first circuit substrate on which the data driving circuit is mounted and to which the temperature sensor is connected, a second circuit substrate on which the sensor driving unit, the timing controller, and the digital to analog converter are mounted, and a third circuit substrate which connects the first circuit substrate and the second circuit substrate, wherein the temperature signal is supplied to the sensor driving unit through the first, second and third circuit substrates.

In one exemplary embodiment of a display device, the temperature sensor is formed in a non-display area adjacent to a boundary of a display area of the display panel and senses a temperature of the display area of the display panel.

One exemplary embodiment of the present invention further includes a heat diffusion sheet disposed below the display panel which diffuses heat from the display panel.

One exemplary embodiment of the present invention a plurality of temperature sensors is formed on the display panel and the sensor driving unit calculates an average of the temperature signals supplied from the plurality of the temperature sensors and digitally converts the average value into the digital temperature signal.

In one exemplary embodiment, the timing controller stores a reference value corresponding to an optimal temperature of the display panel and compares the reference value with the digital temperature signal.

In one exemplary embodiment the timing controller generates a first gamma reference control signal when the digital temperature signal is smaller than the reference value, and generates a second gamma reference control signal lowering the gamma reference voltage when the temperature signal is greater than the reference value.

In one exemplary embodiment the digital to analog converter raises the gamma reference voltage when it receives the first gamma reference control signal and lowers the gamma reference voltage when it receives the second gamma reference control signal.

In one exemplary embodiment, the sensor driving unit stores a reference value corresponding to an optimal temperature of the display panel, and compares the reference value with the temperature signal supplied from the temperature sensor to generate a comparison signal, wherein the timing controller receives the comparison signal and generates the gamma reference voltage control signal corresponding to the comparison signal.

In another exemplary embodiment of the present invention, a method of driving an organic light emitting diode display device includes measuring a temperature of the organic light emitting diode display panel and generating a temperature signal, converting the temperature signal into a digital temperature signal, generating a gamma reference voltage which varies with the gamma reference voltage control signal.

In one exemplary embodiment of a method of driving an organic light emitting diode display device the temperature of the organic light emitting diode display panel is measured at a plurality of positions on the organic light emitting diode display panel and the digital temperature signal is generated by converting an average value of the measured temperatures of the organic light emitting diode display panel.

The exemplary embodiment of a method of driving an organic light emitting diode display device of the present invention includes storing a reference value corresponding to an optimal temperature of the organic light emitting diode display panel, and generating a first gamma reference voltage control signal when the digital temperature signal is smaller than the reference value and a second gamma reference voltage control signal when the digital temperature signal is greater than the reference value.

The exemplary embodiment of a method of driving an organic light emitting diode display device of the present invention includes raising the gamma reference voltage when the first gamma reference voltage control signal is generated and lowering the gamma reference voltage when the second gamma reference control signal is generated.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a graph showing a variation of brightness according to temperature of a conventional organic light emitting diode (“OLED”) display;

FIG. 2 is a top plan view showing an exemplary embodiment of an OLED display device in accordance with the present invention;

FIG. 3 is an equivalent circuit diagram showing an exemplary embodiment of a pixel cell of the exemplary embodiment of an OLED display device shown in FIG. 2;

FIG. 4 is a cross-sectional view showing the exemplary embodiment of an OLED display device in accordance with the present invention.

FIG. 5 is a block diagram illustrating an exemplary embodiment of a driving method of the exemplary embodiment of an OLED display device in accordance with the present invention;

FIG. 6 is a graph showing maximum values of gamma reference voltages varying with temperature, and a gamma curve at each maximum value in accordance with an exemplary embodiment of the present invention; and

FIG. 7 is a graph showing a variation of the gamma reference voltages with time in the exemplary embodiment of an OLED display device in accordance with the present invention.

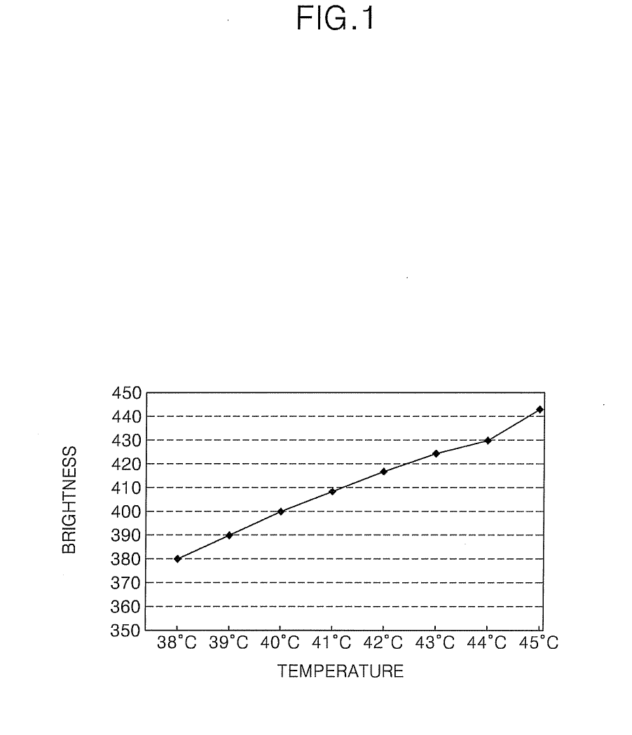

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower” can, therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

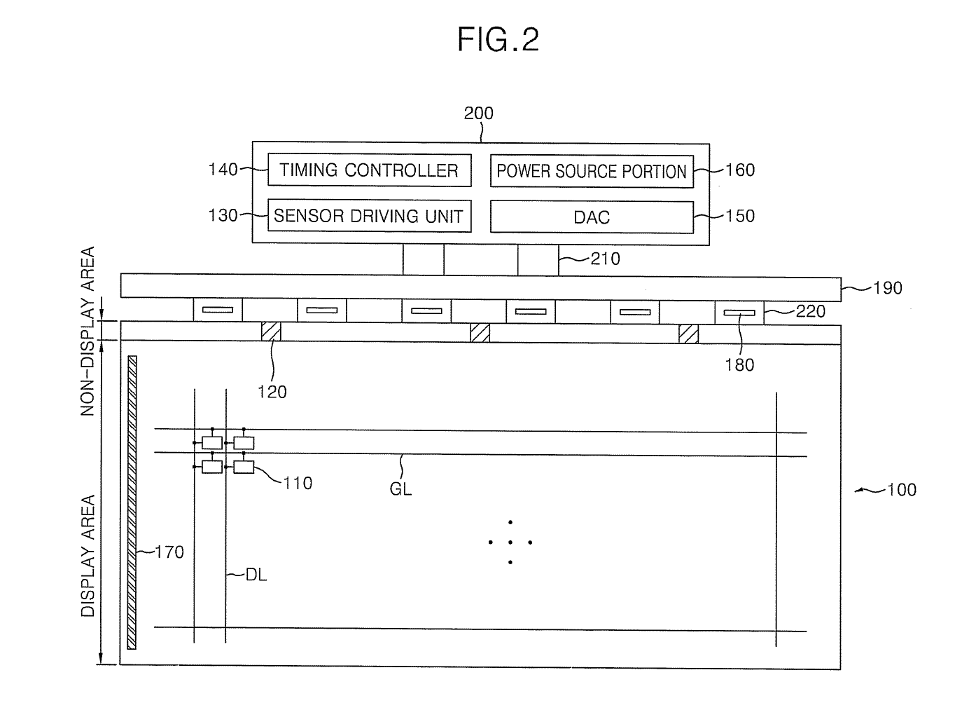

Hereinafter, exemplary embodiments of the present invention will now be described in detail with reference to FIGS. 2 to 6.

FIG. 2 is a top plan view showing an exemplary embodiment of an organic light emitting diode (“OLED”) display device in accordance with the present invention.

Referring to FIG. 2, the exemplary embodiment of an OLED display device according to the present invention provides an OLED display panel 100 including pixel cells 110. Each of the pixel cells 110 are arranged in an area defined by an intersection of a gate line GL and a data line DL. The OLED display device also includes a gate driving circuit 170 and a data driving circuit 180 driving the gate line GL and the data line DL, respectively. At least one temperature sensor 120 is formed on the OLED display panel 100 to sense a temperature of the OLED display panel 100 and to supply a temperature signal to a sensor driving unit 130. The sensor driving unit 130 converts the temperature signal supplied from the temperature sensor 120 into a digital temperature signal. The OLED display device also includes a timing controller 140 which supplies the gate driving circuit 170 with a control signal, supplies the data driving circuit 180 with the control signal and a data signal, and generates a gamma reference voltage control signal which controls a change of a gamma reference voltage AVDD according to the digital temperature signal supplied from the sensor driving unit 130. AVDD is an acronym commonly associated with an analog supply voltage; the gamma reference voltage AVDD functions as an analog supply voltage. The OLED display device also includes a digital to analog converter (“DAC”) 150 which generates the gamma reference voltage AVDD which has been modified according to the gamma reference voltage control signal generated by the timing controller 140. The OLED display device further includes a power source portion 160 which supplies the gate and data driving circuits 170, 180, the temperature sensor 120, an organic light emitting element (“OLEE”), and the digital to analog converter 150 with a power source.

An exemplary embodiment of the gate driving circuit 170 formed on the OLED display panel 100 will be explained in more detail below. In the current exemplary embodiment the data driving circuit 180 is mounted on a circuit film 220 and is connected with the OLED display panel 100 and a data printed circuit board (“PCB”) 190, respectively. The gate driving circuit 170, the temperature sensors 120, the pixel cells 110, and the gate and data lines GL and DL may also be formed on the OLED display panel 100. In the current exemplary embodiment the sensor driving unit 130, the timing controller 140, the power source portion 160, and the digital to analog converter 150 are mounted on a main PCB 200. The data PCB 190 and the main PCB 200 are connected through a circuit substrate, one exemplary embodiment of which is a flexible printed circuit (“FPC”) 210.

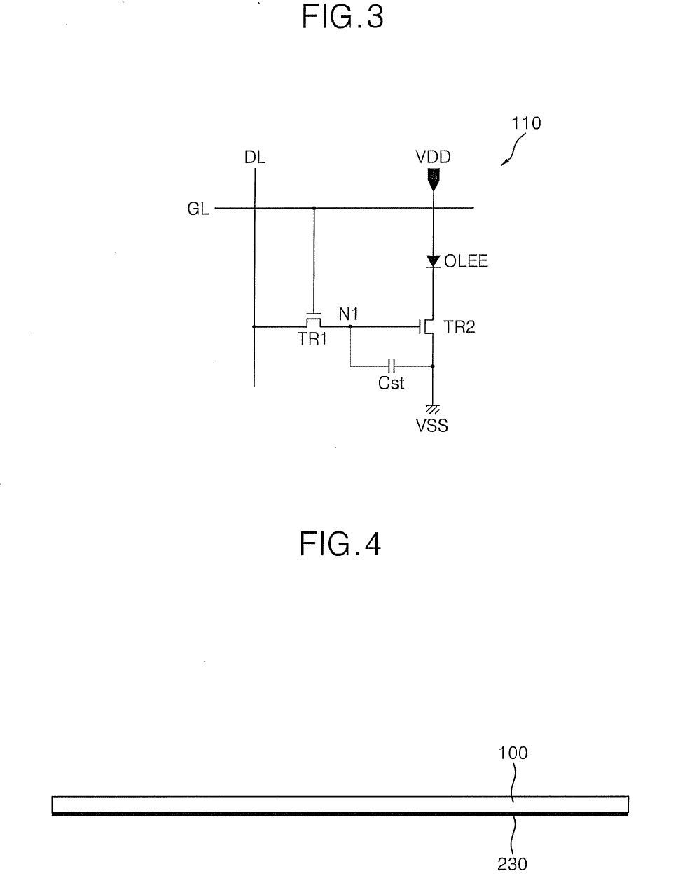

Referring to FIGS. 2 and 3, the OLED display panel 100 includes a plurality of gate lines GL intersecting with a plurality of data lines DL which divide a pixel area into a plurality of pixel cells 110 as shown in FIG. 2. As shown in FIG. 3, the pixel cell 110 includes a first transistor TR1 and a second transistor TR2, which controls the organic light emitting element OLEE.

The gate line GL supplies the first transistor TR1, which is formed in the pixel area, with a scan signal supplied from the gate driving circuit 170 to drive the first transistor TR1.

The data line DL supplies the first transistor TR1 with the data signal supplied from the data driving circuit 180 whenever the scan signal is supplied to the gate line GL.

The first transistor TR1 is turned on when the scan signal is supplied to the gate line GL. When turned on, the first transistor TR1 supplies a first node N1 with the data signal supplied from the data line DL. The data signal supplied from the first node N1 is charged in a storage capacitor Cst. Herein, when the first transistor TR1 is turned off, the data signal charged in the storage capacitor Cst is supplied to the second transistor TR2. Accordingly, the organic light emitting element OLEE is operated by an electric current supplied from the power source portion 160 under the control of the second transistor TR2.

The organic light emitting element OLEE includes an anode electrode, exemplary embodiments of which are formed of an opaque conductive material such as a metal, a cathode electrode opposing the anode electrode, exemplary embodiments of which are formed of a transparent conductive material, and an organic emission layer disposed between the anode and cathode electrodes. In one exemplary embodiment the organic emission layer is made of several layers which each emit light of various colors including red, green and blue. The organic emission layer includes, starting sequentially from the anode, a hole injection layer, a hole transfer layer, a light emitting layer, an electron transfer layer, and an electron injection layer. The organic light emitting element OLEE injects an electron into the light emitting layer from the cathode through the electron injection layer and the electron transfer layer, and injects a hole into the light emitting layer from the anode through the hole injection layer and the hole transfer layer. The electron and the hole are combined within the light emitting layer to emit light. When the hole and electron combine, they form an exciton, which is a bound state of an electron and a hole. The exciton then de-excites, releasing energy in the form of a photon. That photon may have an energy in the visible wavelength and may therefore be used to display images.

The data driving circuit 180 includes different types of driving circuits including an analog type which receives an analog data signal supplied from the timing controller 140 and correspondingly outputs an analog voltage, and a digital type which receives a digital data signal and correspondingly outputs an analog voltage.

Herein, an exemplary embodiment of a digital type data driving circuit 180 will now be described. The digital type of the data driving circuit 180 receives the gamma reference voltage AVDD supplied from the digital to analog converter 150 and converts the digital data signal into an analog voltage using the gamma reference voltage AVDD. Whenever the scan signal is supplied along the gate line GL from the gate driving circuit 170 to one of the pixel cells 110, an analog voltage is supplied to a corresponding pixel through the data line DL and charged in the storage capacitor Cst connected with the first transistor TR1. The magnitude of the analog voltage, which has been modified according to the level of the gamma reference voltage AVDD, is supplied to the data line DL. Accordingly, the temperature of the OLED display panel 100 may be controlled by limiting the amount of an electric current flowing in the organic light emitting element OLEE by modifying the magnitude of the analog voltage charged in the storage capacitor Cst and the level of the voltage driving the second transistor TR2.

The power source portion 160 generates a gate-on voltage VON and a gate-off voltage VOFF which turns the first transistor TR1 on and off, and supplies the gate-on voltage VON and the gate-off voltage VOFF to the gate driving circuit 170. The power source portion 160 generates a power source signal VDD supplied to the organic light emitting element OLEE and a common voltage Vcom supplied to the common electrode of the OLEE, wherein the common electrode may be the cathode or the anode of the OLEE. The power source portion 160 also generates and supplies the power source signal for generating analog voltages to the data driving circuit 180. The power source portion 160 generates and supplies reference voltages for generating the gamma reference voltage AVDD to the digital to analog converting portion 150 as will be described in more detail below.

The temperature sensor 120 is formed on the OLED display panel 100 in a location where it may sense heat generated from the organic light emitting element OLEE within the OLED display panel 100. The temperature sensor 120 converts the sensed temperature into a temperature signal. In one exemplary embodiment the temperature signal may be one of a voltage or current signal. A plurality of temperature sensors 120 is formed in a non-display area of the OLED display panel 100. In one exemplary embodiment the temperature sensors 120 are formed separated by a constant distance and each supply the sensor driving unit 130 with the temperature signal measured at each location. Each of the temperature sensors 120 is formed substantially adjacent to a display area of the OLED display panel 100 and accurately measures the temperature of the display area of the OLED display panel 100. The temperature signal generated at the temperature sensor 120 is supplied to the sensor driving unit 130 through the circuit film 220 mounted on the data driving circuit 180.

The sensor driving unit 130 supplies driving signals to the plurality of the temperature sensors 120 and converts the temperature signal supplied from the temperature sensors 120 into a digital temperature signal which may be controlled in the timing controller 140. For example, the sensor driving unit 130 converts the temperature signal (e.g., an analog signal) supplied from the temperature sensors 120 into a digital temperature signal. The sensor driving unit 130 calculates an average of the temperature signals supplied from the temperature sensors 120 and converts the analog signal into the digital temperature signal.

The timing controller 140 supplies the gate driving circuit 170 and the data driving circuit 180 with a control signal. Specifically, the timing controller 140 generates a gate control signal GCS which adjusts a timing of the scan signal supplied through the gate line GL. The timing controller 140 generates a data control signal DCS which adjusts a timing of the data signal supplied through the data line DL in accordance with the scan signal. The timing controller supplies the data driving circuit 180 with the data control signal DCS. Further, the timing controller 140 supplies the data driving circuit 180 with the data signal, such as red, green and blue (R, G, B) inputs, supplied from an outside. The timing controller 140 generates a gamma reference voltage control signal which is used by the digital to analog converter 150 to modify the gamma reference voltage AVDD according to the signal supplied from the sensor driving unit 130.

In one exemplary embodiment the timing controller 140 stores a reference value corresponding to an optimal temperature of the OLED display panel 100, and compares the reference value with the digital temperature signal supplied from the sensor driving unit 130. If the digital temperature signal is larger than the reference value, the timing controller 140 outputs the gamma reference voltage control signal instructing the digital to analog converter 150 to lower the gamma reference voltage AVDD. If the digital temperature signal is smaller than the reference value, the timing controller 140 outputs the gamma reference voltage control signal instructing the digital to analog converter 150 to raise the gamma reference voltage AVDD.

In another exemplary embodiment the reference value which corresponds to the optimal temperature of the OLED display panel 100 may be stored in the sensor driving unit 130. In other words, the reference value stored in the sensor driving unit 130 is compared with the temperature signal supplied from the temperature sensor 120 and then the compared signal is supplied to the timing controller 140. In this exemplary embodiment the timing controller 140 outputs the gamma reference voltage control signal in accordance with the compared signal supplied from the sensor driving unit 130.

The digital to analog converter 150 varies the gamma reference voltage in accordance with the gamma reference voltage control signal digitally supplied from the timing controller 140, and supplies the data driving circuit 180 with the modified gamma reference voltage AVDD. Accordingly, the data driving circuit 180 outputs the gamma value as described above, and controls an electric current supplied to the organic light emitting element OLEE, thereby controlling the temperature of the OLED display panel 100.

In one exemplary embodiment the OLED display panel 100 further includes a heat diffusion sheet 230 which further allows the OLED display panel 100 to maintain a constant internal temperature as shown in FIG. 4.

In one exemplary embodiment the heat diffusion sheet 230 is affixed to the lower portion of the OLED display panel 100 and diffuses heat throughout its dimensions. The diffusing properties of the heat diffusion sheet 230 spread the heat from the display panel 100 so that each portion of the OLED display panel 100 has a substantially uniform heat distribution. The heat diffusion sheet 230 makes the temperatures of the center and the peripheral portion of the OLED display panel 100 substantially uniform, and thus the temperature of the OLED display panel 100 obtained through the temperature sensors 120 formed on the non-display area is accurately indicative of the temperature throughout the display panel 100. Accordingly, the heat diffusion sheet 230 may uniformly maintain the temperature of the OLED display panel 100 and also prevent generation of an error of the temperature of the OLED display panel 100 measured at the temperature sensors 120.

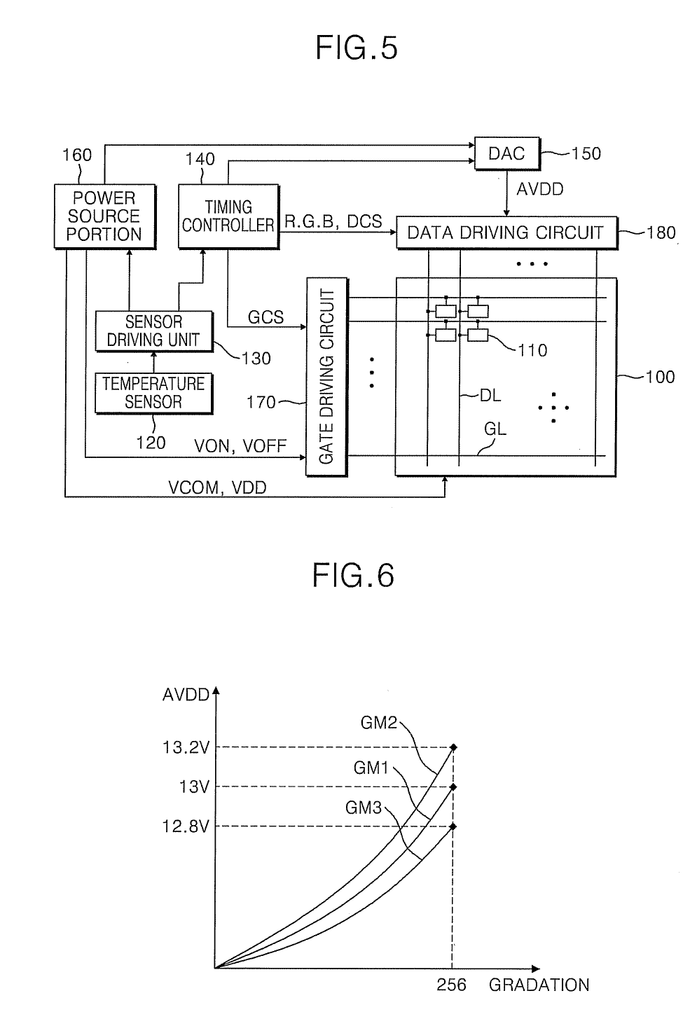

FIG. 5 is a block diagram illustrating an exemplary embodiment of a driving method of the exemplary embodiment of an OLED display device in accordance with the present invention.

Referring to FIG. 5, the driving method of the OLED display device includes measuring the temperature of the OLED display panel 100 at the temperature sensor 120, which is formed on the OLED display panel 100, converting the temperature signal into a digital temperature signal, generating a gamma reference voltage control signal according to the digital temperature signal, and generating the modified gamma reference voltage by the gamma reference voltage control signal.

More specifically, the temperature of the OLED display panel 100 is measured at the temperature sensor 120 and the corresponding temperature signal is output. At this time, the temperature signal is supplied to the sensor driving unit 130 as an analog signal. In one exemplary embodiment a plurality of the temperature sensors 120 is formed on the OLED display panel 100 and the temperature signal generated at each temperature sensor 120 is substantially simultaneously supplied to the sensor driving unit 130.

Next, the temperature signals supplied from the temperature sensors 120 are received by the sensor driving unit 130, an average of the temperature signals is calculated, the average value of the temperature signal is converted into a digital temperature signal, and then the digital temperature signal is supplied to the timing controller 140.

Meanwhile, a reference value corresponding to an optimal temperature of the OLED display panel 100 may be stored in the sensor driving unit 130, the reference value may be compared with the temperature signal, and the comparison signal may be supplied to the timing controller 140. In other words, an optimal brightness of the OLED display device is determined according to user's demand or usage of OLED display device and the temperature of the OLED display panel 100 corresponding to the optimal brightness is stored as the reference value. The reference value is then stored in a memory of the sensor driving unit 130, and then as the temperature signals are input, the temperature signals are compared with the reference value to output a comparison signal. The comparison signal is output as a value obtained by a difference between the reference value and the temperature signal and the comparison signal is sent to the timing controller 140 in the form of a digital temperature signal.

As described above, the power source portion 160 generates the gate-on voltage VON and the gate-off voltage VOFF which turns the first transistor TR1 on and off, and supplies the gate-on voltage VON and the gate-off voltage VOFF to the gate driving circuit 170. The power source portion 160 generates the power source signal VDD supplied to the organic light emitting element OLEE and the common voltage Vcom supplied to the common electrode of the organic light emitting element OLEE, wherein the common electrode may be the cathode or the anode of the organic light emitting element OLEE. The power source portion 160 also generates and supplies the power source signal for generating analog voltages to the data driving circuit 180. The power source portion 160 generates and supplies reference voltages for generating the gamma reference voltage AVDD to the digital to analog converting portion 150.

The timing controller 140 outputs the gamma reference voltage control signal for modifying the gamma reference voltage AVDD in accordance with a digital temperature signal supplied from the sensor driving unit 130 along with the gate control signal GCS sent to the gate driver 170 and the data control signal DCS and the data signal RGB sent to the data driver 180. In one exemplary embodiment when the brightness is 400 nit, the temperature of the OLED display panel 100 corresponding to the brightness of 400 nit is measured to be 40° C. Then if during operation of the OLED display device the temperature of the OLED display panel 100 is measured by the temperature sensors 120 to be more than 40° C., a control signal lowering the level of the gamma reference voltage AVDD is generated to reduce the temperature of the OLED display panel 100. In contrast, when the temperature of the OLED display panel 100 is measured by the temperature sensors 120 to be less than 40° C., a control signal raising the level of the gamma reference voltage AVDD is generated to increase the temperature of the OLED display panel 100.

Then, the gamma reference voltage AVDD, which is modified at the digital to analog converter 150 according to the gamma reference voltage control signal supplied from the timing controller 140, is output. The digital to analog converter 150 varies the level of the reference voltage supplied from the power source portion 160 according to the gamma reference voltage control signal supplied from the timing controller 140, and supplies data driving circuit 180 with the gamma reference voltage AVDD.

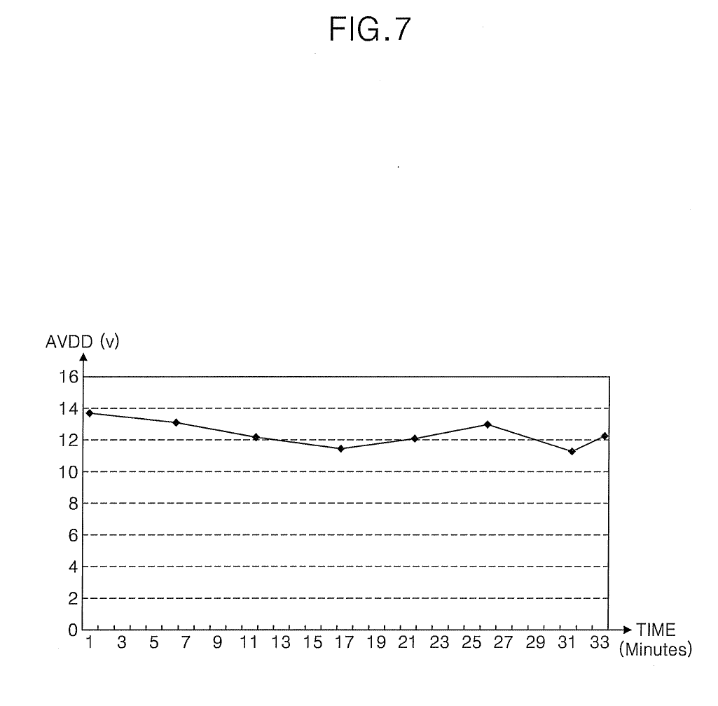

In another exemplary embodiment, the driving method of the OLED display device may further include storing a reference value of the temperature signal corresponding to the optimal value in the timing controller 140. In other words, the reference value may be stored in the timing controller 140 and the temperature of the OLED display panel 100 may be constantly maintained according to the reference value. As shown in FIG. 6, the gamma reference voltage AVDD has a different value at the same gray. For example, in a 256 gray display, when the temperature of the OLED display panel 100 is 40° C., a first gamma curve GM1 is formed having a maximum reference voltage value of 13V. A second gamma curve GM2 is formed when the temperature of the OLED display panel 100 is less than 40° C. and the maximum value of the gamma reference voltage AVDD is increased to 13.2V. When the temperature of the OLED display panel 100 is more than 40° C., a gamma voltage is determined along a third gamma curve GM3 and the maximum value of the gamma reference voltage AVDD is reduced to 12.8V. As such, the gamma reference voltage varies up or down with respect to the reference value according to a temperature variation of the OLED display panel 100 as shown in FIG. 7. Accordingly, this results in optimally maintaining the temperature of the OLED display panel 100 and improving uniformity of the image quality.

Then, the data driving circuit 180 generates the analog voltage using the gamma reference voltage applied from the digital to analog converting portion 150, and supplies the data line DL with the analog voltage according to a gray scale of the data signal.

As described above, the OLED display device may vary the gamma reference voltage according to the temperature variation and constantly maintain the temperature of the OLED display panel, thereby improving uniformity of an image quality.

Although the exemplary embodiments of the present invention have been describes, it is understood that the present invention should not be limited to these exemplary embodiments but various changes and modifications can be made by one ordinary skilled in the art within the sprit and scope of the present invention as hereinafter claimed.

What is claimed is:

1. A display device comprising:
a display panel including a pixel connected to a gate line and a data line;
a gate driving circuit which drives the gate line;
a data driving circuit which drives the data line;
at least one temperature sensor disposed on the display panel which senses a temperature of the display panel;
a sensor driving unit which converts a temperature signal supplied from the temperature sensor into a digital temperature signal;
a timing controller which supplies the gate driving circuit with a control signal, supplies the data driving circuit with a control signal and a data signal, and generates a gamma reference voltage control signal according to the digital temperature signal supplied from the sensor driving unit; and
a digital to analog converter which generates a gamma reference voltage which varies according to the gamma reference voltage control signal and supplies the data driving circuit with the gamma reference voltage.

2. The display device of claim 1, further comprising:
a first circuit substrate on which the data driving circuit is mounted and to which the temperature sensor is connected;
a second circuit substrate on which the sensor driving unit, the timing controller, and the digital to analog converter are mounted; and
a third circuit substrate which connects the first circuit substrate and the second circuit substrate,
wherein the temperature signal is supplied to the sensor driving unit through the first, second and third circuit substrates.

3. The display device of claim 2, wherein the temperature sensor is formed in a non-display area adjacent to a boundary of a display area of the display panel and senses a temperature of the display area of the display panel.

4. The display device of claim 3, further comprising a heat diffusion sheet disposed below the display panel which diffuses heat from the display panel.

5. The display device of claim 1, wherein a plurality of temperature sensors is formed on the display panel and the sensor driving unit calculates an average of the temperature signals supplied from each of the plurality of the temperature sensors and converts the average value into the digital temperature signal.

6. The display device of claim 5, wherein the timing controller stores a reference value corresponding to an optimal temperature of the display panel and compares the reference value with the digital temperature signal.

7. The display device of claim 6, wherein the timing controller generates a first gamma reference control signal when the digital temperature signal is smaller than the reference value, and generates a second gamma reference control signal when the digital temperature signal is greater than the reference value.

8. The display device of claim 7, wherein the digital to analog converter raises the gamma reference voltage when it receives the first gamma reference control signal and lowers the gamma reference voltage when it receives the second gamma reference control signal.

9. The display device of claim 5, wherein the sensor driving unit stores a reference value corresponding to an optimal temperature of the display panel, and compares the reference value with the temperature signal supplied from the temperature sensor to generate a comparison signal,
wherein the timing controller receives the comparison signal and generates the gamma reference voltage control signal corresponding to the comparison signal.

10. A method of driving an organic light emitting diode display device, the method comprising:
measuring a temperature of the organic light emitting diode display panel and generating a temperature signal;
converting the temperature signal into a digital temperature signal;
generating a gamma reference voltage control signal in accordance with the digital temperature signal; and
generating a gamma reference voltage which varies with the gamma reference voltage control signal

11. The method of claim 10, wherein the temperature of the organic light emitting diode display panel is measured at a plurality of positions on the organic light emitting diode display panel and the digital temperature signal is generated by converting an average value of the measured temperatures of the organic light emitting diode display panel.

12. The method of claim 11, further comprising:
storing a reference value corresponding to an optimal temperature of the organic light emitting diode display panel; and
generating a first gamma reference voltage control signal when the digital temperature signal is smaller than the reference value and a second gamma reference voltage control signal when the digital temperature signal is greater than the reference value.

13. The method of claim 12, further comprising:
raising the gamma reference voltage when the first gamma reference voltage control signal is generated and lowering the gamma reference voltage when the second gamma reference control signal is generated.
